(19) United States
(12) Patent Application Publication
(10) Pub. No.: US 2025/0053413 A1
(43) Pub. Date: Feb. 13, 2025

(54) IMAGE EFFECT PACKAGE GENERATION METHOD AND APPARATUS, DEVICE, AND STORAGE MEDIUM

(71) Applicant: BEIJING BYTEDANCE NETWORK TECHNOLOGY CO., LTD., Beijing (CN)

(72) Inventors: Yang LV, Beijing (CN); Ruifeng MA, Beijing (CN)

(21) Appl. No.: 18/717,980

(22) PCT Filed: Dec. 6, 2022
(86) PCT No.: PCT/CN2022/136771

§ 371 Date: Jun. 7, 2024

(30) Foreign Application Priority Data
Dec. 10, 2021 (CN) 202111506370.9

(51) Int. Cl. G06F 8/658; G06T 11/00

(52) U.S. Cl. CPC G06F 8/658; G06T 11/00

(57) ABSTRACT

The present disclosure provides an image effect package generation method and apparatus, device, and storage medium. The method for generating an image effects package comprises: switching to a general effects graph based on an operation of creating general effects triggered by a user; creating, in the general effects graph, an image input control, at least one effects control and a scenario output control in accordance with a creation operation triggered by a user; sequentially connecting the image input control, the at least one effects control and the scenario output control according to set rules based on a connection operation triggered by a user; building an effects information array and a mesh information array in accordance with a connecting order of the at least one effects control; generating an image effects package in accordance with the effects information array and the mesh information array.

The present application claims a priority right of the Chinese patent application filed on Dec. 10, 2021, and having the Chinese application No. 202111506370.9, which is incorporated herein by reference in its entirety.

### FIELD

The present disclosure relates to the field of computer software technology, e.g., to an image effect package generation method and apparatus, device, and storage medium.

### BACKGROUND

Intelligent terminals have been more extensively applied and users would perform effects processing on filmed or recorded videos through the intelligent terminals. Applications (APP) will provide plenty of effects templates. As such, it becomes particularly vital to generate effects packages in batch

### SUMMARY

The present disclosure provides a method, an apparatus, a device and a storage medium for generating an image effects package. Accordingly, an effects package is generated based on the node system and the generation efficiency of the effects package is improved.

In a first aspect, the present disclosure provides a method for generating an image effects package, comprising:
switching to a general effects graph based on an operation of creating general effects triggered by a user;
creating, in the general effects graph, an image input control, at least one effects control and a scenario output control in accordance with a creation operation triggered by a user; wherein the effects control carries effects information and mesh information;
sequentially connecting the image input control, the at least one effects control and the scenario output control according to set rules based on a connection operation triggered by a user;
building an effects information array and a mesh information array in accordance with a connecting order of the at least one effects control; wherein element order in the effects information array and the mesh information array corresponds to a connecting order of the at least one effects control;
generating an image effects package in accordance with the effects information array and the mesh information array.

In a second aspect, the present disclosure also provides an apparatus for generating an image effects package, comprising:
a general effects graph switching module configured to switch to a general effects graph based on an operation of creating general effects triggered by a user;
a control creating module configured to create, in the general effects graph, an image input control, at least one effects control and a scenario output control in accordance with a creation operation triggered by a user; wherein the effects control carries effects information and mesh information;
a control connecting module configured to sequentially connect the image input control, the at least one effects control and the scenario output control by set rules based on a connection operation triggered by a user;
an array building module configured to build an effects information array and a mesh information array in accordance with a connecting order of the at least one effects control; wherein element order in the effects information array and the mesh information array corresponds to a connecting order of the at least one effects control;
an image effects package generating module configured to generate an image effects package in accordance with the effects information array and the mesh information array.

In a third aspect, the present disclosure also provides an electronic device, comprising:
one or more processors;
a memory storing one or more programs which, when executed by the one or more processing means, cause the one or more processors to perform the above method for generating an image effects package.

In a fourth aspect, the present disclosure also discloses a computer readable medium storing computer programs which, when processed by a processor, cause the processor to perform the above method for generating an image effects package.

### BRIEF DESCRIPTION OF THE DRAWINGS

FIG. 1 is a flowchart of a method for generating an image effects package in accordance with an embodiment of the present disclosure;

FIG. 2 is an example diagram of switching to the general effects graph in accordance with an embodiment of the present disclosure;

FIG. 3 is an example diagram of creating a function control in accordance with an embodiment of the present disclosure;

FIG. 4 is an example diagram of connecting function controls in accordance with an embodiment of the present disclosure;

FIG. 5 is an example diagram of tuning general parameters in accordance with an embodiment of the present disclosure;

FIG. 6 is a structural diagram of an apparatus for generating an image effects package in accordance with an embodiment of the present disclosure;

FIG. 7 is a structural diagram of an electronic device provided by one embodiment of the present disclosure.

### DETAILED DESCRIPTION OF EMBODIMENTS

The embodiments of the present disclosure will be described below with reference to the drawings. Although the drawings illustrate some embodiments of the present disclosure, it should be appreciated that the present disclosure can be implemented in various manners. These embodiments are provided to better understand the present disclosure. The drawings and the embodiments of the present disclosure are provided only for exemplary purposes.

Various steps in the method implementations of the present disclosure may be executed by different orders and/or in parallel. Besides, the method implementations may include additional steps and/or omit the shown steps. The scope of the present disclosure is not restricted in this aspect.

As used herein, the term “includes” and its variants are to be read as open-ended terms that mean “includes, but is not limited to.” The term “based on” is to be read as “based at least in part on.” The term “one embodiment” is to be read as “at least one embodiment.” The term “a further embodiment” is to be read as “at least a further embodiment.” The term “some embodiments” is to be read as “at least some embodiments”. Related definitions of other terms may be provided in the following description.

It is to be noted that “first” and “second” are disclosed in the present disclosure merely for distinguishing different apparatuses, modules or units, rather than restricting the sequence of the functions executed by the apparatuses, modules or units or the interdependency among the apparatuses, modules or units.

It is to be noted that the terms “one” and “more” disclosed in the present disclosure are exemplary rather than restrictive. Those skilled in the art should understand that the above terms are to be read as “one or more” unless indicated otherwise in the context.

Names of the messages or information exchanged between a plurality of apparatuses in the implementations of the present disclosure are provided only for explanatory purpose, rather than restricting the scope of the messages or information.

A general effects graph (Effect Graph) in a node system may perform effects processing on one or more pictures.

Effect Graph is developed based on Mesh Renderer System and its core is a mesh renderer component, containing an array of effects information (material) and an array of mesh information (mesh). The numbers of the two arrays are in one-to-one correspondence. Each pair of material and mesh information is used to perform effects rendering on one picture, so as to produce a picture with effects. This output picture with effects may serve as an input for next effects processing, to implement a combined effect. In case that an input of a material relies on an output of a further material, it is required that a relied party should be placed before the relying party in the array, to ensure that the relying party is at a correct execution sequence and is capable of obtaining a correct output result.

Through connections of a plurality of controls in Effect Graph, material and mesh are conveniently configured while the ordering relation is maintained to ensure correct execution of each control. Effect Graph includes effects controls, image input controls (consisting of built-in image input control and static image input control) and scenario output controls as core function controls and other expanded function controls. The working principle of Effect Graph is to be explained in the text mainly from the workflow of the core function controls.

The core of Effect Graph is effects controls, where each effects control may be configured with a pair of material and mesh for rendering picture effects. Each effects control may have an output, being a picture with effects. The output of this effects control may either be input to the scenario output control or to a next effects control. Each effects control may receive single or multiple inputs, and the input may be a built-in image, or a picture with effects output by other effects controls or a static image. All of the images are provided in the material owned by the effects control and available for rendering. If the output picture with effects is connected to a scenario output control, it indicates that the rendering result of the current effects control can be observed in the scenario.

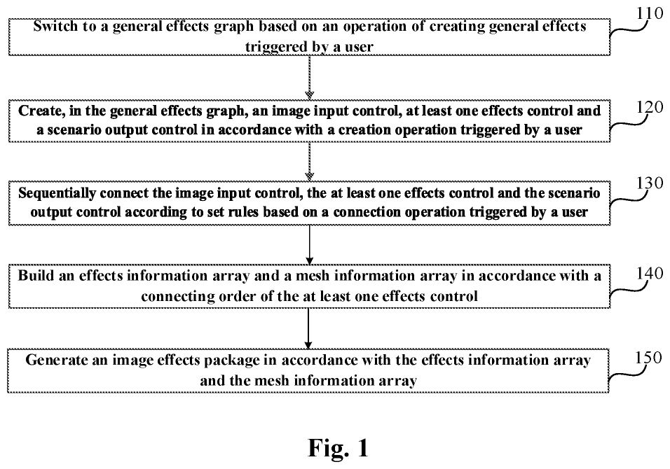

FIG. 1 is a flowchart of a method for generating an image effects package in accordance with an embodiment of the present disclosure. This embodiment is adapted to a scenario where the image effects package is generated based on the node system. The method may be executed by an apparatus for generating an image effects package, which apparatus may consist of hardware and/or software and is generally integrated in a device capable of generating image effects packages. The device may be a server, a mobile terminal or a server cluster among other electronic devices. As shown in FIG. 1, the method includes following steps:

Step 110: switching to a general effects graph based on an operation of creating general effects triggered by a user.

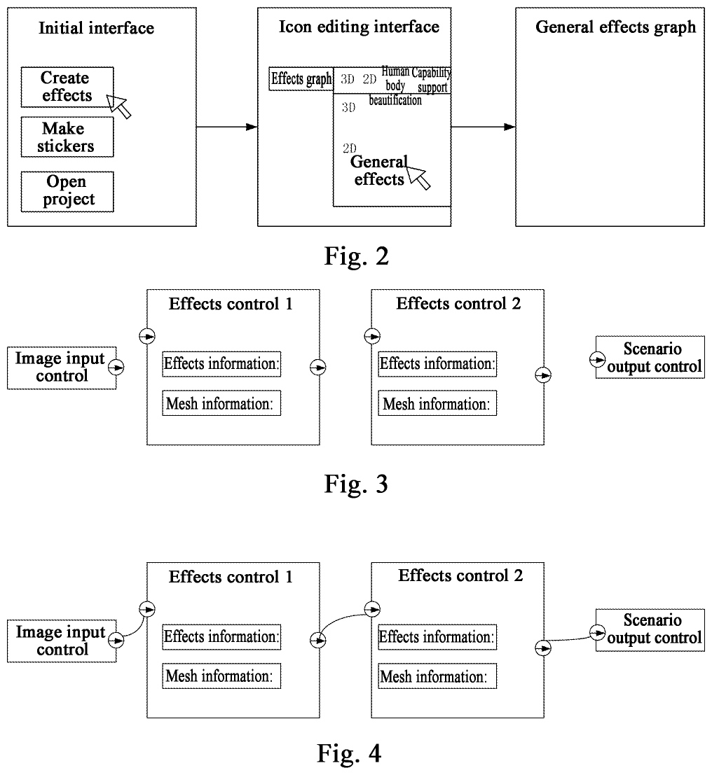

In this embodiment, the user enters an initial interface of the node system after opening the node system via a terminal device, and clicks “Create Effects” in the initial interface to go into an icon editing (Graph) interface. The user selects “General effects” in a drop-down option of the effects graph in Graph interface, to switch the interface to the general effects graph. As an example, FIG. 2 is an example diagram of switching to the general effects graph in accordance with an embodiment of the present disclosure. According to FIG. 2, there are three options in the initial interface, respectively being “Create Effects”, “Make Stickers” and “Open Project”. By clicking “Create Effects” button, the user enters the icon editing interface. The drop-down option of the effects graph in the icon editing interface includes three dimension (3D) function, 2D function, human body beautification function and capability support function. Further, the 2D function consists of “general effects”, by selecting which the user enters the general effects graph.

Step 120: creating, in the general effects graph, an image input control, at least one effects control and a scenario output control in accordance with a creation operation triggered by a user.

The effects control carries effects information and mesh information. The image input control is provided to input pictures to utilize subsequent effects processing. The image input control may include a built-in image input control and a static image input control, where the built-in image input control may input pictures captured by a camera head of the current terminal device and the static image input control may input pictures already stored by the terminal device (such as Joint Photographic Experts Group, JPG, format, and Portable Network Graphics, PNG, format). The function of the effects control may be adding effects to the input picture. The effects control may be provided with effects information and mesh information, where the effects information may be the effects (e.g., mirroring, denoising and the like) added to the image to be processed by the effects control and the mesh information may be size and position of the effects added in the image to be processed by the effects control. The mesh information may include mesh vertex coordinates and normal information etc. For example, the mesh information may be a full-screen quadrangle, indicating effects processing on the entire picture. The scenario output control is provided to display the picture after the effects processing.

In this embodiment, the quantity of the effects control and the effects function of each effects control may be selected by the user in view of the required effects package in practice and will not be limited here. As an example, assuming that the user intends to create an effects package of “mirroring+amplification+added heart”, the user is required to create three effects controls having mirroring, amplification and heart adding functions.

After the interface is switched to the general effects graph, the user opens “Add Control” menu by right clicking the mouse. This menu contains an image input control, effects controls of various functions and a scenario output control. The user creates a function control by selecting these controls. As an example, FIG. 3 is an example diagram of creating a function control in accordance with an embodiment of the present disclosure. According to FIG. 3, the user creates one image input control, two effects controls and one scenario output control.

A process of creating, in the general effects graph, at least one effects control in accordance with a creation operation triggered by a user includes: creating, in the general effects graph, at least one initial effects control in accordance with a creation operation triggered by a user; and receiving effects information and mesh information set by the user in the at least one initial effects control, to obtain a final effects control.

The effects information and the mesh information may be embedded in the node system in the form of program packages. After the initial effects control is created, the desired effects information is selected from the drop-down menu of the effects information and the desired mesh information is selected from the drop-down menu of the mesh information, to complete the creation of the effects control.

Step 130: sequentially connecting the image input control, the at least one effects control and the scenario output control according to set rules based on a connection operation triggered by a user.

The set rules may include: the image input control being a starting node; the effects control being an intermediate node; the scenario output control being an ending node; input of the effects control being non-empty; connections among the effects controls failing to form a closed loop. In this embodiment, the effects control includes one or more input ends and one output ends; an input end of the effects control is connected to an output end of the image input control or an output end of a further effects control; an output end of the effects control is connected to an input end of a further effects control or an input end of the scenario output control.

Starting from the image input control, the effects controls are sequentially connected in accordance with the desired effects sequence and the scenario output control is an ending node. As an example, FIG. 4 is an example diagram of connecting function controls in accordance with an embodiment of the present disclosure. As shown in FIG. 4, the output of the image input control is connected to the input of the effects control 1; the output of the effects control 1 is connected to the input of the effects control 2; and the output of the effects control 2 is connected to the input of the scenario output control. In this way, the image input to the image input control first passes the effects control 1. The effects control 1 performs effects processing on the image. The processed image is then input to the effects control 2. The effects control 2 continues to perform effects processing on the image. The resulting image is finally input to the scenario output control to display the final image added with combined effects.

Step 140: building an effects information array and a mesh information array in accordance with a connecting order of the at least one effects control.

The element order in the effects information array and the mesh information array corresponds to a connecting order of the at least one effects control. The effects controls are connected in the following order: the effects controls closer to the image input are connected earlier and the effects controls closer to the scenario output control are connected later. As shown in FIG. 4, the effects control 1 is connected first and then the effects control 2.

A process of building an effects information array and a mesh information array in accordance with a connecting order of the at least one effects control may include: sequentially traversing the at least one effects control in accordance with the connecting order; storing effects information of effects controls traversed after previous effects information in effects information array and storing mesh information of effects controls traversed after previous mesh information in mesh information array; obtaining the effects information array and the mesh information array until completing traversing all effects controls.

In this embodiment, the first effects control is traversed first, to obtain the effects information and the mesh information of the first effects control; the effects information is stored as a first element of the effects information array and the mesh information is stored as a first element of the mesh information array. The second effects control is then traversed to obtain the effects information and the mesh information of the second effects control; and the effects information is stored as a second element of the effects information array and the mesh information is stored as a second element of the mesh information array. The rest can be done in the same manner until all effects controls are traversed and the effects information array and the mesh information array are obtained.

Step 150: generating an image effects package in accordance with the effects information array and the mesh information array.

After obtaining the effects information array and the mesh information array, the user clicks the effects package export button in the general effects graph to obtain the image effects package.

In one embodiment, the general effects graph includes a general parameter area; before the generating an image effects package in accordance with the effects information array and the mesh information array, the method further comprises: tuning the general parameters in accordance with a tuning operation of the user in the general parameter area.

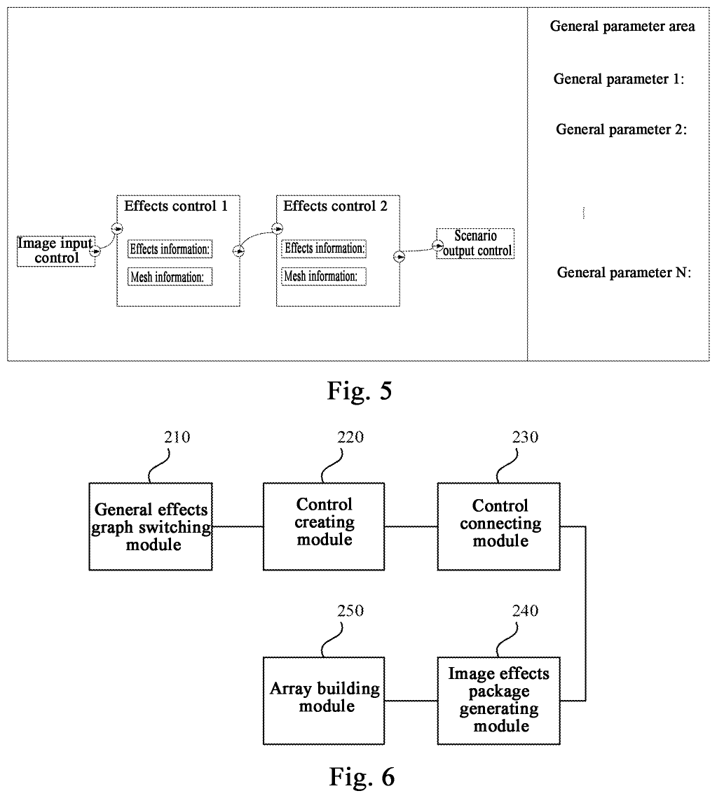

The general parameters may include rendering sequence, output length, width and angle of the picture etc. As an example, FIG. 5 is an example diagram of tuning general parameters in accordance with an embodiment of the present disclosure. As shown in FIG. 5, to the right of the general effects graph, there is a general parameter area, in which parameters that can be tuned are displayed. By tuning these general parameters, the user may self-define the output effects of the effects package.

Correspondingly, the generating an image effects package in accordance with the effects information array and the mesh information array includes: generating an image effects package in accordance with the effects information array, the mesh information array and tuned general parameters. As a result, the generated image effects package contains effects information array, mesh information array and tuned general parameters among other information.

The technical solution of the embodiments of the present disclosure includes: switching to a general effects graph based on an operation of creating general effects triggered by a user; creating, in the general effects graph, an image input control, at least one effects control and a scenario output control in accordance with a creation operation triggered by a user; wherein the effects control carries effects information and mesh information; sequentially connecting the image input control, the at least one effects control and the scenario output control according to set rules based on a connection operation triggered by a user; building an effects information array and a mesh information array in accordance with a connecting order of the at least one effects control; wherein element order in the effects information array and the mesh information array corresponds to a connecting order of the at least one effects control; and generating an image effects package in accordance with the effects information array and the mesh information array. The method for generating an image effects package disclosed by embodiments of the present disclosure may generate an effects package based on the node system and improve the generation efficiency of the effects package.

FIG. 6 is a structural diagram of an apparatus for generating an image effects package in accordance with an embodiment of the present disclosure. As shown in FIG. 6, the apparatus comprises:
a general effects graph switching module 210 configured to switch to a general effects graph based on an operation of creating general effects triggered by a user; a control creating module 220 configured to create, in the general effects graph, an image input control, at least one effects control and a scenario output control in accordance with a creation operation triggered by a user; wherein the effects control carries effects information and mesh information; a control connecting module 230 configured to sequentially connect the image input control, the at least one effects control and the scenario output control according to set rules based on a connection operation triggered by a user; an array building module 240 configured to build an effects information array and a mesh information array in accordance with a connecting order of the at least one effects control; wherein element order in the effects information array and the mesh information array corresponds to a connecting order of the at least one effects control; an image effects package generating module 250 configured to generate an image effects package in accordance with the effects information array and the mesh information array.

In one embodiment, the control creating module 220 is configured to:
create, in the general effects graph, at least one initial effects control in accordance with a creation operation triggered by a user; receive effects information and mesh information configured by the user in the at least one initial effects control, to obtain a final effects control.

In one embodiment, the set rules include: the image input control being a starting node; the effects control being an intermediate node; the scenario output control being an ending node; input of the effects control being non-empty; connections among the effects controls failing to form a closed loop.

In one embodiment, the array building module 240 is configured to:
sequentially traverse the at least one effects control in accordance with the connecting order; store effects information of effects controls traversed after previous effects information in effects information array and store mesh information of effects controls traversed after previous mesh information in mesh information array; obtain the effects information array and the mesh information array until completing traversing all effects controls

In one embodiment, the general effects graph includes a general parameter area; the apparatus also comprises a parameter tuning module configured to:
tune the general parameters in accordance with a tuning operation of the user in the general parameter area; the generating an image effects package in accordance with the effects information array and the mesh information array includes:
generating an image effects package in accordance with the effects information, the mesh information array and tuned general parameters.

In one embodiment, the effects information characterizes effects added to an image to be processed by the effects control; the mesh information characterizes size and position of effects added in the image to be processed by the effects control.

In one embodiment, the effects control includes one or more input ends and one output end; an input end of the effects control is connected to an output end of the image input control or an output end of a further effects control; an output end of the effects control is connected to an input end of a further effects control or an input end of the scenario output control.

The above apparatus may execute the method provided by all of the above embodiments of the present disclosure, include corresponding functional modules for performing the above method and achieve advantageous effects. Technical details not elaborated in this embodiment may refer to the method provided by all of the above embodiments of the present disclosure.

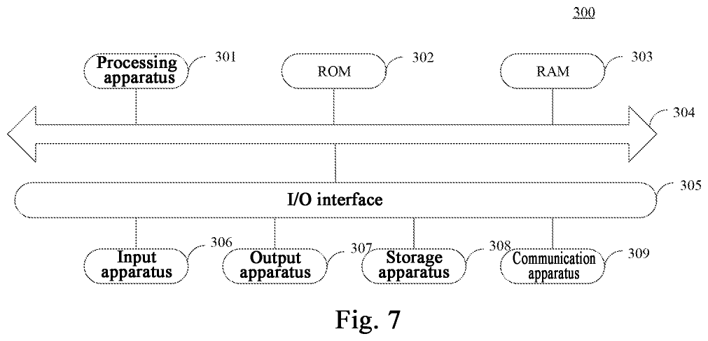

Next, FIG. 7 illustrates a structural diagram of an electronic device 300 for implementing embodiments of the present disclosure. In the embodiments of the present disclosure, the electronic device may include, but not limited to, mobile terminals, such as mobile phones, notebooks, digital broadcast receivers, PDAs (Personal Digital Assistant), PADs (tablet computer), PMPs (Portable Multimedia Player) and vehicle terminals (such as car navigation terminal) and fixed terminals, e.g., digital TVs and desktop computers etc., or servers in various forms, such as independent server or server cluster. The electronic device 300 shown in FIG. 7 is just an example and will not put any restrictions on the functions and application ranges of the embodiments of the present disclosure.

According to FIG. 7, the electronic device 300 may include a processing apparatus (e.g., central processor, graphic processor and the like) 301, which can execute various suitable actions and processing based on the programs stored in the read-only memory (ROM) 302 or programs loaded in the random-access memory (RAM) 303 from a storage apparatus 308. The RAM 303 can also store all kinds of programs and data required by the operations of the electronic device 300. Processing apparatus 301, ROM 302 and RAM 303 are connected to each other via a bus 304. The input/output (I/O) interface 305 is also connected to the bus 304.

Usually, input apparatus 306 (including touch screen, touchpad, keyboard, mouse, camera, microphone, accelerometer, gyroscope and like) and output apparatus 307 (including liquid crystal display (LCD), speaker and vibrator etc.), storage apparatus 308 (including tape and hard disk etc.) and communication apparatus 309 may be connected to the I/O interface 305. The communication apparatus 309 may allow the electronic device 300 to exchange data with other devices through wired or wireless communications. Although FIG. 7 illustrates the electronic device 300 having various units, it is to be understood that it is not a prerequisite to implement or provide all illustrated units. Alternatively, more or less units may be implemented or provided.

In accordance with embodiments of the present disclosure, the process depicted above with reference to the flowchart may be implemented as computer software programs. For example, the embodiments of the present disclosure include a computer program product including computer programs carried on a non-transient computer readable medium, wherein the computer programs include program codes for executing the method of generating an image effects package. In these embodiments, the computer programs may be loaded and installed from networks via the communication apparatus 309, or installed from the storage apparatus 308, or installed from the ROM 302. The computer programs, when executed by the processing apparatus 301, performs the above functions defined in the method for video editing according to the embodiments of the present disclosure.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and radio frequency (RF) etc., or any suitable combinations thereof.

In some implementations, clients and servers may communicate with each other via any currently known or to be developed network protocols, such as HyperText Transfer Protocol (HTTP) and interconnect with digital data communications in any forms or media (such as communication networks). Examples of the communication networks include Local Area Network (LAN), Wide Area Network (WAN), internet work (e.g., Internet) and end-to-end network (such as ad hoc end-to-end network), and any currently known or to be developed networks.

The above computer readable medium may be included in the aforementioned electronic device or stand-alone without fitting into the electronic device.

The above computer readable medium bears one or more programs. When the above one or more programs are executed by the electronic device, the electronic device is enabled to: switch to a general effects graph based on an operation of creating general effects triggered by a user; create in the general effects graph an image input control, at least one effects control and a scenario output control in accordance with a creation operation triggered by a user; wherein the effects control carries effects information and mesh information; sequentially connect the image input control, the at least one effects control and the scenario output control according to set rules based on a connection operation triggered by a user; build an effects information array and a mesh information array in accordance with a connecting order of the at least one effects control; wherein an element order in the effects information array and the mesh information array corresponds to a connecting order of the at least one effects control; generate an image effects package in accordance with the effects information array and the mesh information array.

Computer program instructions for executing operations of the present disclosure may be written in one or more programming languages or combinations thereof. The above programming languages include, but not limited to, object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including LAN and WAN, or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

In accordance with one or more embodiments of the present disclosure, there is disclosed a method for generating an image effects package, comprising:
switching to a general effects graph based on an operation of creating general effects triggered by a user;
creating, in the general effects graph, an image input control, at least one effects control and a scenario output control in accordance with a creation operation triggered by a user; wherein the effects control carries effects information and mesh information;
sequentially connecting the image input control, the at least one effects control and the scenario output control according to set rules based on a connection operation triggered by a user;
building an effects information array and a mesh information array in accordance with a connecting order of the at least one effects control; wherein element order in the effects information array and the mesh information array corresponds to a connecting order of the at least one effects control;
generating an image effects package in accordance with the effects information array and the mesh information array.

In one embodiment, wherein creating, in the general effects graph, at least one effects control in accordance with a creation operation triggered by a user includes:
creating, in the general effects graph, at least one initial effects control in accordance with a creation operation triggered by a user;
receiving effects information and mesh information configured by the user in the at least one initial effects control, to obtain a final effects control.

In one embodiment, the set rules include: the image input control being a starting node; the effects control being an intermediate node; the scenario output control being an ending node; input of the effects control being non-empty; connections among the effects controls failing to form a closed loop.

In one embodiment, the building an effects information array and a mesh information array in accordance with a connecting order of the at least one effects control includes:
sequentially traversing the at least one effects control in accordance with the connecting order;
storing effects information of effects controls traversed after previous effects information in effects information array and storing mesh information of effects controls traversed after previous mesh information in mesh information array;
obtaining the effects information array and the mesh information array until completing traversing all effects controls.

In one embodiment, the general effects graph includes a general parameter area; before the generating an image effects package in accordance with the effects information array and the mesh information array, the method further comprises:
tuning the general parameters in accordance with a tuning operation of the user in the general parameter area; and
the generating an image effects package in accordance with the effects information array and the mesh information array includes:
generating an image effects package in accordance with the effects information, the mesh information array and tuned general parameters.

In one embodiment, the effects information characterizes effects added to an image to be processed by the effects control; the mesh information characterizes size and position of effects added in the image to be processed by the effects control.

In one embodiment, the effects control includes at least one input end and one output end; an input end of the effects control is connected to an output end of the image input control or an output end of a further effects control; an output end of the effects control is connected to an input end of a further effects control or an input end of the scenario output control.

1. A method for generating an image effects package, comprising:
switching to a general effects graph based on an operation of creating general effects triggered by a user;
creating, in the general effects graph, an image input control, at least one effects control, and a scenario output control in accordance with a creation operation triggered by the user, wherein the effects control carries effects information and mesh information;
sequentially connecting the image input control, the at least one effects control, and the scenario output control according to set rules, based on a connection operation triggered by the user;
building an effects information array and a mesh information array in accordance with a connecting order of the at least one effects control, wherein an element order in the effects information array and the mesh information array corresponds to a connecting order of the at least one effects control; and
generating the image effects package in accordance with the effects information array and the mesh information array.

2. The method of claim 1, wherein the creating, in the general effects graph, the at least one effects control in accordance with the creation operation triggered by the user comprises:
creating, in the general effects graph, at least one initial effects control in accordance with the creation operation triggered by the user; and
receiving effects information and mesh information set by the user in the at least one initial effects control, to obtain a final effects control.

3. The method of claim 1, wherein the set rules comprise: the image input control being a starting node, the effects control being an intermediate node, the scenario output control being an ending node, input of the effects control being non-empty, and connections among the effects controls failing to form a closed loop.

4. The method of claim 1, wherein the building the effects information array and the mesh information array in accordance with the connecting order of the at least one effects control comprises:
sequentially traversing the at least one effects control in accordance with the connecting order;
storing effects information of an effects control traversed after previous effect information in the effects information array, and storing mesh information of the effects control traversed after previous mesh information in the mesh information array; and
obtaining the effects information array and the mesh information array until completing traversing all effects controls.

5. The method of claim 1, wherein the general effects graph comprises a general parameter area, before the generating the image effects package in accordance with the effects information array and the mesh information array, the method further comprises:
tuning a general parameter in accordance with a tuning operation of the user in the general parameter area; and
wherein the generating the image effects package in accordance with the effects information array and the mesh information array comprises:
generating the image effects package in accordance with the effects information array, the mesh information array, and the tuned general parameter.

6. The method of claim 1, wherein the effects information characterizes effects added to an image to be processed by the effects control, and the mesh information characterizes size and position of effects added in the image to be processed by the effects control.

7. The method of claim 1, wherein the effects control comprises at least one input end and one output end; an input end of the effects control is connected to an output end of the image input control or an output end of a further effects control, and an output end of the effects control is connected to an input end of a further effects control or an input end of the scenario output control.

8. (canceled)

9. An electronic device, comprising:
at least one processor;
a memory storing at least one program which, when executed by the at least one processor, causes the at least one processor to perform operations comprising:
switching to a general effects graph based on an operation of creating general effects triggered by a user;
creating, in the general effects graph, an image input control, at least one effects control, and a scenario output control in accordance with a creation operation triggered by the user, wherein the effects control carries effects information and mesh information;
sequentially connecting the image input control, the at least one effects control, and the scenario output control according to set rules, based on a connection operation triggered by the user;
building an effects information array and a mesh information array in accordance with a connecting order of the at least one effects control, wherein an element order in the effects information array and the mesh information array corresponds to a connecting order of the at least one effects control; and
generating the image effects package in accordance with the effects information array and the mesh information array.

10. A non-transitory computer readable storage medium storing computer programs which, when executed by a processor, causes the processor to perform operations comprising:
switching to a general effects graph based on an operation of creating general effects triggered by a user;
creating, in the general effects graph, an image input control, at least one effects control, and a scenario output control in accordance with a creation operation triggered by the user, wherein the effects control carries effects information and mesh information;
sequentially connecting the image input control, the at least one effects control, and the scenario output control according to set rules, based on a connection operation triggered by the user;
building an effects information array and a mesh information array in accordance with a connecting order of the at least one effects control, wherein an element order in the effects information array and the mesh information array corresponds to a connecting order of the at least one effects control; and
generating the image effects package in accordance with the effects information array and the mesh information array.

11. The electronic device of claim 9, wherein the creating, in the general effects graph, the at least one effects control in accordance with the creation operation triggered by the user comprises:
creating, in the general effects graph, at least one initial effects control in accordance with the creation operation triggered by the user; and
receiving effects information and mesh information set by the user in the at least one initial effects control, to obtain a final effects control.

12. The electronic device of claim 9, wherein the set rules comprise: the image input control being a starting node, the effects control being an intermediate node, the scenario output control being an ending node, input of the effects control being non-empty, and connections among the effects controls failing to form a closed loop.

13. The electronic device of claim 9, wherein the building the effects information array and the mesh information array in accordance with the connecting order of the at least one effects control comprises:
sequentially traversing the at least one effects control in accordance with the connecting order;
storing effects information of an effects control traversed after previous effect information in the effects information array, and storing mesh information of the effects control traversed after previous mesh information in the mesh information array; and
obtaining the effects information array and the mesh information array until completing traversing all effects controls.

14. The electronic device of claim 9, wherein the general effects graph comprises a general parameter area, before the generating the image effects package in accordance with the effects information array and the mesh information array, the operations further comprises:
tuning a general parameter in accordance with a tuning operation of the user in the general parameter area; and
wherein the generating the image effects package in accordance with the effects information array and the mesh information array comprises:
generating the image effects package in accordance with the effects information array, the mesh information array, and the tuned general parameter.

15. The electronic device of claim 9, wherein the effects information characterizes effects added to an image to be processed by the effects control, and the mesh information characterizes size and position of effects added in the image to be processed by the effects control.

16. The electronic device of claim 9, wherein the effects control comprises at least one input end and one output end; an input end of the effects control is connected to an output end of the image input control or an output end of a further effects control, and an output end of the effects control is connected to an input end of a further effects control or an input end of the scenario output control.

17. The non-transitory computer readable storage medium of claim 10, wherein the creating, in the general effects graph, the at least one effects control in accordance with the creation operation triggered by the user comprises:
creating, in the general effects graph, at least one initial effects control in accordance with the creation operation triggered by the user; and
receiving effects information and mesh information set by the user in the at least one initial effects control, to obtain a final effects control.

18. The non-transitory computer readable storage medium of claim 10, wherein the set rules comprise: the image input control being a starting node, the effects control being an intermediate node, the scenario output control being an ending node, input of the effects control being non-empty, and connections among the effects controls failing to form a closed loop.

19. The non-transitory computer readable storage medium of claim 10, wherein the building the effects information array and the mesh information array in accordance with the connecting order of the at least one effects control comprises:
sequentially traversing the at least one effects control in accordance with the connecting order;
storing effects information of an effects control traversed after previous effect information in the effects information array, and storing mesh information of the effects control traversed after previous mesh information in the mesh information array; and
obtaining the effects information array and the mesh information array until completing traversing all effects controls.

20. The non-transitory computer readable storage medium of claim 10, wherein the general effects graph comprises a general parameter area, before the generating the image effects package in accordance with the effects information array and the mesh information array, the operations further comprises:
tuning a general parameter in accordance with a tuning operation of the user in the general parameter area; and
wherein the generating the image effects package in accordance with the effects information array and the mesh information array comprises:
generating the image effects package in accordance with the effects information array, the mesh information array, and the tuned general parameter.

21. The non-transitory computer readable storage medium of claim 10, wherein the effects information characterizes effects added to an image to be processed by the effects control, and the mesh information characterizes size and position of effects added in the image to be processed by the effects control.
